(19) United States
(12) Patent Application Publication
(10) Pub. No.: US 2026/0084528 A1
(43) Pub. Date: Mar. 26, 2026

(54) Defining Alert Zones for an Agricultural Vehicle

(71) Applicant: AGCO International GmbH, Neuhausen (CH)

(72) Inventors: Martin Peter Christiansen, Randers (DK); Morten Stigaard Laursen, Randers (DK)

(21) Appl. No.: 19/108,901

(22) PCT Filed: Sep. 8, 2023
(86) PCT No.: PCT/IB2023/058913

§ 371 Date: Mar. 5, 2025

(30) Foreign Application Priority Data
Sep. 29, 2022 (GB) 2214262.4

(51) Int. Cl. B60K 35/28; A01B 76/00; G05D 1/622; G05D 105/15; G06V 20/58

(52) U.S. Cl. CPC B60K 35/28; A01B 76/00; G05D 1/637; G06V 20/58; B60K 2360/167; B60K 2360/178; B60K 2360/179; G05D 2105/15

(57) ABSTRACT

A mechanism for defining an alert zone surrounding an agricultural vehicle. The size and/or shape of side zones, that span alongside the agricultural vehicle, of the alert zone are defined or modified responsive to one or more characteristics of an implement that is being towed by the agricultural vehicle.

### CROSS-REFERENCE TO RELATED APPLICATIONS

Not applicable.

### FIELD OF THE INVENTION

Embodiments of the present disclosure generally relate to the field of agricultural vehicles.

### BACKGROUND OF THE INVENTION

In modern agricultural environments, there is an ever-increasing use and reliance upon agricultural vehicles, such as a tractors, (combine) harvesters or mowers. When carrying out agricultural practices using an agricultural vehicle, it is common for the agricultural vehicle to be towing an implement. Example implements may include a harrow, a planter, a plough, a roller, a seed drill, fertilizing apparatus, sprayers, wagons, mowing equipment, rakes, (hay) balers and so on.

The size of the agricultural vehicle, as well as that of any implements towed by such vehicles (which are often much larger), results in a strong desire to provide an alert system to inform an operator of any nearby persons or objects. Such an alert system will provide the agricultural vehicle with the capability to detect the presence of target objects in its vicinity.

Typically, such approaches comprise a perception system that is able to detect, identify and locate a target object in the vicinity of the agricultural vehicle. Known approaches make use of LiDAR, RADAR, ultrasound or (visual/optical) camera based technologies. An alert may be generated if a target object gets too close to the agricultural vehicle, e.g., enters an alert zone surrounding the agricultural vehicle.

### SUMMARY OF THE INVENTION

The invention is defined by the claims.

According to examples in accordance with an aspect of the invention, there is provided a computer-implemented method for defining an alert zone that surrounds an agricultural vehicle towing an implement from a rear of the agricultural vehicle.

The computer-implemented method comprises: defining, in the alert zone, a first side zone and a second side zone positioned on either side of the agricultural vehicle and spanning from a front of the agricultural vehicle to the rear of the agricultural vehicle; obtaining an implement indicator providing information on one or more characteristics of the implement; and defining a size and/or shape of at least the first side zone and the second side zone in dependence on the implement indicator.

The present disclosure provides a mechanism for defining an alert zone that (completely) surrounds an agricultural vehicle. The alert zone can, for instance, be used to define an area or region in which target objects (e.g., individuals, animals or hazardous objects such as fences, walls or posts) should not be present.

The first side zone spans along a first side of the agricultural vehicle, from a front of the agricultural vehicle to a rear of the agricultural vehicle. The first side zone spans along a second, different side of the agricultural vehicle (opposite to the first side), from the front of the agricultural vehicle to the rear of the agricultural vehicle.

The size and/or shape of the first and second side zones is responsive to the implement indicator. Thus, the size and/or shape of the first and second side zones of the alert zone changes as/if the implement indicator changes.

The proposed approach recognizes that the implement being towed will affect the level of danger or a collision risk in being at a side of the agricultural vehicle. By modifying the size and/or shape of the side zones of the alert zone, the differences in danger level or risk level can be taken into account in defining the alert zone.

Broadly, an agricultural vehicle may be considered to have a front, a rear, and two sides (e.g., a left and right side). Of course, the agricultural vehicle may also be defined as further comprising a top and a bottom, but these are less relevant for the present disclosure.

The implement indicator may be generated by an implement sensor positioned on the agricultural vehicle. Positioning an implement sensor on the agricultural vehicle facilitates independent determination of the characteristic(s) of the implement, thereby increasing the flexibility and reliability of obtaining the implement indicator.

The implement indicator may provide information on a type or identity of the implement towed by the agricultural vehicle. Different implements will have different effects on the danger levels imposed to objects at a side of the vehicle. For instance, wider implements will impact the danger level to a greater extent in positions or regions that extend outwards from the side of the agricultural vehicle.

The implement indicator may provide information on an angle, in a horizontal plane, between the vehicle and the implement. The angle in the horizontal plane may be an angle that the implement makes with respect to the agricultural vehicle about a free-operating linkage or hitch of the agricultural vehicle. The angle affects the area likely to be occupied by the implement in the future, and therefore the level of danger to an object to the side of the agricultural vehicle.

The implement indicator may provide information on an operational state of the implement. For example, some implements may be defined as “active” implements, who's shape, size and position may vary as a function of its operational state. This may be where, for example, one or more components of the implement may be raised or tilted due to crop conditions, topography, or for maneuverability of the vehicle, for instance. In this manner, the size and/or shape of the first and/or second side zones may be defined and varied in dependence on a varying operational state of the implement.

Active implements may include a harrow, a seeder, a plough, a sprayer, a mulcher, a rake, a tedder, a mower or a spreader, for example. The implement may include a combination of any two or more implement types listed here, and could for example include a harrow plus seeder.

The computer-implemented method may comprise obtaining a vehicle indicator providing information on one or more characteristics of the agricultural vehicle, wherein defining the size and/or shape of the first side zone and the second side zone is further in dependence on the vehicle indicator. The vehicle indicator may provide information on a speed of the agricultural vehicle and/or a steering angle of the agricultural vehicle.

In some examples, the step of defining a size and/or shape of the first side zone and the second side zone comprises: processing the implement indicator and the vehicle indicator to predict a future location of the implement; and defining the size and/or shape of the first side zone in dependence on the predicted future location of the implement.

Preferably, neither the first side zone nor the second side zone cover an area occupied by the implement.

In some examples, the step of defining a size and/or shape of the first side zone and the second side zone comprises, for each of the first and second side zones, defining a size and/or shape of at least a portion of said side zone that spans from the front of the agricultural vehicle to a center-line of the agricultural vehicle, being a line equidistant from the front and rear of the agricultural vehicle, in dependence on the implement indicator.

The method may further comprise defining a second alert zone that surrounds the implement towed by the agricultural vehicle in dependence on the implement indicator.

In some embodiments, the method further comprises obtaining sensor data responsive to the presence of one or more target objects in the vicinity of the agricultural vehicle; processing the sensor data to determine whether or not the one or more target objects are within the alert zone; and controlling an alert signal that indicates whether or not the one or more target objects are within the alert zone.

The method may further comprise controlling, via a user interface, a user-perceptible output responsive to the alert signal; and/or controlling, via a drive control system, a speed of the agricultural vehicle responsive to the alert signal.

There is also proposed a computer program product comprising computer program code means which, when executed on a computing device having a processing system, cause the processing system to perform all of the steps of any herein described method.

There is also proposed an agricultural vehicle configured to tow an implement from a rear thereof, the agricultural vehicle comprising a processing system for defining an alert zone that surrounds the agricultural vehicle.

The processing system is configured to: define, in the alert zone, a first side zone and a second size zone positioned on either side of the agricultural vehicle and spanning from a front of the agricultural vehicle to the rear of the agricultural vehicle; obtain an implement indicator providing information on one or more characteristics of the implement; and define a size and/or shape of the first side zone and the second side zone in dependence on the implement indicator.

The processing system may be configured to carry out the steps of any herein described method, as would be apparent to the skilled person.

These and other aspects of the invention will be apparent from and elucidated with reference to the embodiment(s) described hereinafter.

### BRIEF DESCRIPTION OF THE DRAWINGS

One or more embodiments of the invention/disclosure will now be described, by way of example only, with reference to the accompanying drawings, in which:

FIG. 1 illustrates an agricultural vehicle towing an implement;

FIG. 2 illustrates an alert zone surrounding the agricultural vehicle;

FIG. 3 is a flowchart illustrating a method according to an embodiment;

FIG. 4 illustrates modifications to the alert zone;

FIG. 5 is a flowchart illustrating a variant of the method;

FIG. 6 illustrates an approach for defining the first and second side zones;

FIG. 7 is a flowchart illustrating further optional steps of the method;

FIG. 8 illustrates a processing system for use in an embodiment; and

FIG. 9 provides a more detailed view of the processing system.

### DETAILED DESCRIPTION OF THE EMBODIMENTS

The invention will be described with reference to the figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the figures are merely schematic and are not drawn to scale. It should also be understood that the same reference numerals are used throughout the figures to indicate the same or similar parts.

The invention provides a mechanism for defining an alert zone surrounding an agricultural vehicle. The size and/or shape of side zones, that span alongside the agricultural vehicle, of the alert zone are defined or modified responsive to one or more characteristics of an implement that is being towed by the agricultural vehicle.

Embodiments are based on the realization that the future location of an implement will be characterized by its characteristics, and that the future location influences the level of danger or collision risk (between the implement and target object(s)) in regions to the side(s) of the agricultural vehicle. By controlling the size and/or shape of the side zones, this increased level of collision risk can be taken into account.

Herein disclosed approaches can be employed in an agricultural environment, such as on farms or similar environments.

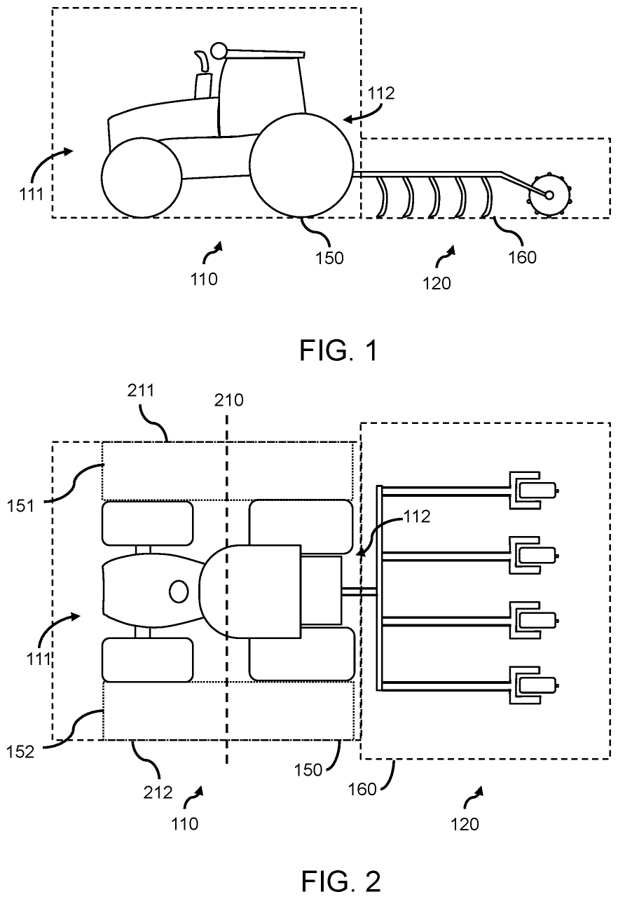

FIG. 1 and FIG. 2 conceptually illustrate an agricultural vehicle 110 towing an implement 120 from a rear thereof. FIG. 1 provides a top-down view, whilst FIG. 2 provides a side view.

In the illustrated example, the agricultural vehicle 110 is a tractor, but other suitable agricultural vehicles will be apparent to the skilled person (e.g., (combine) harvesters or mowers). Similarly, in the illustrated example, the implement 120 is a plough, although other implements will be apparent to the skilled person (e.g., a harrow, a planter, a roller, a seed drill, fertilizing apparatus, a sprayer, a wagon, mowing equipment, a rake, a (hay) baler).

The implement may be coupled to the agricultural vehicle, e.g., by a free-operating linkage.

It is possible to define an alert zone 150 that surrounds the agricultural vehicle 110. Similarly, it is possible to define a second alert zone 160 that surrounds the implement 120. Of course, other alert zones may also be present (e.g., alert zones ahead of the agricultural vehicle or the like).

An alert zone defines a region, area of volume for which it would be desirable to generate an alert if a target object (e.g., a human or solid object such as a wall) is detected within the alert zone. An alert zone thereby defines the bounds of the region for which an alert can be generated if a target object is present therein.

The alert zone may be defined in two-dimensions and/or three-dimensions. Preferably, the alert zone is defined in three-dimensions to reduce the likelihood of a target object within the vicinity of the agricultural vehicle being missed or overlooked.

Approaches for detecting the presence of a target object within an alert zone are well established. In particular, the agricultural vehicle may carry or support a perception system, that monitors the alert zone (e.g., using LiDAR, RADAR, ultrasound and/or camera-based technologies) to identify the presence of any target objects. An alert system may then generate an alert responsive to the perception system detecting the presence of at least one target object. Examples of alerts include visual and/or audio outputs for alerting an operator of the agricultural vehicle

The perception system may comprise a sensor system for generating sensor data that is responsive to the presence of any target objects within the vicinity of the agricultural vehicle. Examples of sensor data are well established in the field, including LiDAR data, RADAR data, ultrasound data and/or image data (e.g., images and/or videos). The sensor system may be appropriately adapted or configured for capturing such data.

The perception system may also comprise an object detection system for processing the sensor data to determine whether or not the one or more target objects are in the alert zone. Approaches for determining whether a target object is within an alert zone based on sensor data are well known in the art. For instance, the relationship between different data points of the sensor data and a position relative to the vehicle/implement may be known or determinable. This relationship can be used to identify data points of the sensor data that represent areas within or on the boundary of the alert zone, and therefore data points that should be processed to identify the presence of any target object within the alert zone. An increasingly popular approach is the use of one or more machine-learning methods to process the sensor data to detect the presence of any target objects within a particular zone or region.

The alert system may generate or control an alert signal that indicates whether or not the one or more target objects are within the alert zone.

One challenge in this field is to set the bounds of the alert zone 150 surrounding the vehicle 110 so that target objects that are sufficiently close (e.g., so as to form a potential hazard or danger) to the vehicle 110 are identified, without being so wide as to generate false alerts for distant objects.

Typically, the alert zone is defined by the size and shape of the agricultural vehicle, e.g., to include a region occupied by the vehicle itself, as well as a region surrounding the immediate vicinity of the vehicle.

The present disclosure proposes an approach for modifying or defining the bounds or region occupied by the alert zone surrounding the agricultural vehicle.

In particular, the present disclosure proposes to define a size and/or shape of at least a first 151 and second 152 side zone of the alert zone 150.

The first side zone and second side zone are positioned on either side of the agricultural vehicle and span from a front 111 of the agricultural vehicle to the rear 112 of the agricultural vehicle. Thus, the first side zone 151 is positioned on one side of the agricultural vehicle and the second side zone 152 is positioned on the other side of the agricultural vehicle.

In particular examples, each side zone includes at least a portion 211, 212 that spans from the front of the agricultural vehicle to a center-line 210 of the agricultural vehicle, being a line equidistant from the front and rear of the agricultural vehicle.

It should be apparent that neither the first side zone 151 nor the second side zone 152 cover an area occupied by the implement. Rather, this area falls within the second alert zone.

As previously explained, the implement 120 is coupled to the rear 112 of the agricultural vehicle. The front 111 is a side in a driving direction of the vehicle 110 (when the vehicle is driving forward).

More particularly, the size and/or shape of the side zones 151, 152 is defined responsive to (i.e. in dependence on) an implement indicator. The implement indicator provides information on one or more characteristics of the implement, such as a type or identity of the implement. Other example characteristics that may be provided in the implement indicator, as will be explained later in this document, include information of an angle that the implement makes with respect to the vehicle, or an operational state of the implement, where the implement is an active implement, for example.

In preferred examples, the side and/or shape of the portion 211, 212, of each side zone, that spans from the front of the agricultural vehicle to the center-line 210 of the agricultural vehicle is in dependence (i.e., responsive to) the implement indicator. Thus, as the implement indicator changes, for example because the implement changes or an operational state of an active implement changes, so does the size and/or shape of the said portions of one or each side zone.

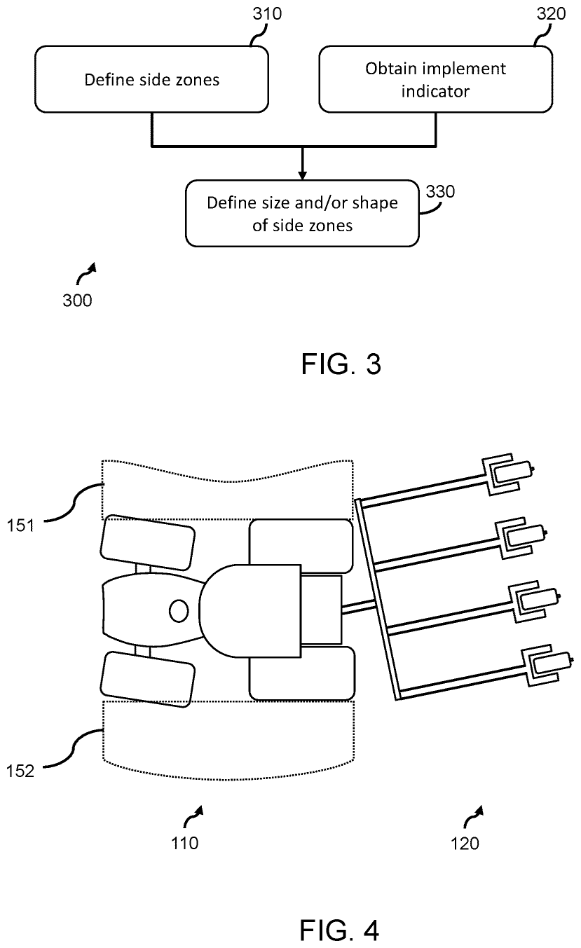

FIG. 3 illustrates a computer-implemented method 300 for defining the alert zone according to an embodiment. The computer-implemented method may, for instance, be performed by a perception system that monitors the alert zone, or by another processing system that provides the defined alert zone to the perception system.

The method 300 comprises a step 310 of defining, in the alert zone, a first side zone and a second side zone. As previously explained, the side zones are positioned on either side of the agricultural vehicle and span from a front of the agricultural vehicle to the rear of the agricultural vehicle.

The method 300 also comprises a step 320 of obtaining an implement indicator providing information on one or more characteristics of the implement. The implement indicator may, for instance, be generated by an implement sensor positioned on the agricultural vehicle. An implement sensor is any sensor or device capable of generating information about one or more characteristics of the implement, examples of which will be later described.

The method 300 also comprises a step 330 of defining a size and/or shape of at least the first side zone and the second side zone in dependence on the implement indicator.

In particular, step 330 may comprise, for each of the first and second side zones, defining a size and/or shape of at least a portion of said side zone that spans from the front of the agricultural vehicle to a center-line of the agricultural vehicle, being a line equidistant from the front and rear of the agricultural vehicle, in dependence on the implement indicator.

Conceptually, characteristics of the implement will affect a future location of the implement and/or the location of regions that will be influenced by the implement in the future. It is herein recognized that the side zones are regions that may become occupied or otherwise influenced by the towed implement as the vehicle moves forward. By using one or more characteristics of the implement to set the size and/or shape of the side zones, then this movement of the implement can be taken into account and used to modify the alert zone, e.g., for alerting to the presence of objects in areas that the implement is likely to occupy or influence/endanger in the future.

In particular, it has been identified that portions of the side zones towards the front of the vehicle are likely to become occupied by, or otherwise endangered/influenced by, the implement, but that the likelihood of occupation or endangerment within such portions is dependent upon characteristics of the implement.

In a simple example, the size of the first side zone and second side zone may be dependent upon a size/width of the implement. In particular, the size of the side zones may be increased/decreased proportional to the size of the implement. This approach would provide a larger alert zone if the implement is larger. This approach effectively provides a simplified approach for anticipating the area that will become occupied by the implement with forward movement of the agricultural vehicle, and may therefore pose a danger to a subject or individual in the area.

As an example, the side zones may be configured such that a total width of the first alert zone (i.e., in a direction perpendicular to a forward direction of the vehicle) is no less than the width of the implement.

In a variation of or modification to this simple example, the size of the first side zone and second side zone may be dependent upon a type and/or identity of the implement. Different implements will have different sizes, which are defined by the type and/or identity of the implement. Thus, the type and/or identity of the implement may be used to determine a size for the first and second side zones.

These approaches recognizes that different implements will impact the danger posed to objects in the first and second side zones. In particular, larger or wider implements will have an increased level of danger or potential danger (e.g., as the vehicle propels forward) compared to smaller or narrower implements.

In one example, the implement indicator provides information on an angle, in a horizontal plane, between the vehicle and the implement. The angle that the implement makes with the vehicle will affect a potential path or route taken by the implement as the agricultural vehicle moves forward. This will affect the regions occupied by the implement with forward movement of the agricultural vehicle.

Thus, the size and/or shape of the side zones can be controlled to take account of the angle between the vehicle and the implement, to anticipate the future location(s) of the implement as the vehicle moves forward. In particular, the shape of the side zones may be modified or controlled to match an expected shape of an area that will become occupied or endangered by the implement with forward movement of the agricultural vehicle. This can be readily characterized based on at least the angle of the implement (as well as other optional characteristics, such as a size, identity and/or type of the implement).

The angle in the horizontal plane may be an angle that the implement makes with respect to the agricultural vehicle about a free-operating linkage or hitch of the agricultural vehicle.

By way of example, the angle that the implement makes with respect to the agricultural vehicle may define a direction that the implement will make with respect to forwards movement of the agricultural vehicle. The first and/or second side zones may be configured or shaped to extend from a rear of the agricultural vehicle towards an expected movement direction of the implement. This thereby ensures that the side zones occupy an area that is likely to become occupied by the implement in the future.

FIG. 4 conceptually illustrates the effect of an angled implement on the shape of the side zones 151, 152 according to such a control scheme. For the sake of illustrative clarity, only the first side zone 151 and second side zone 152 of the alert zone are illustrated.

It will also be appreciated that the movement or steering direction of the agricultural vehicle itself will also affect a future location of the implement. For instance, if a vehicle is performing a turn, the region that the implement will occupy during the turn will change (i.e., no longer be directly ahead of the implement).

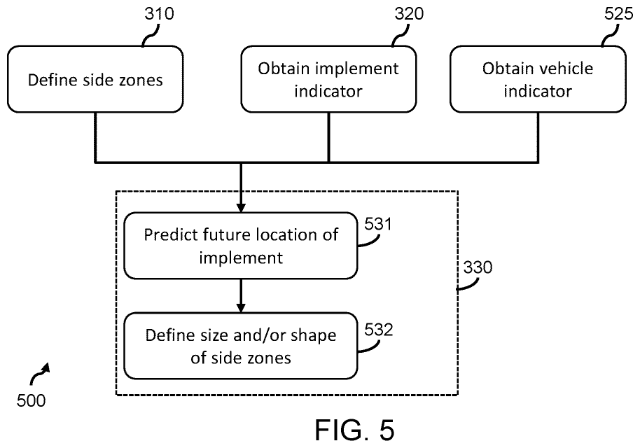

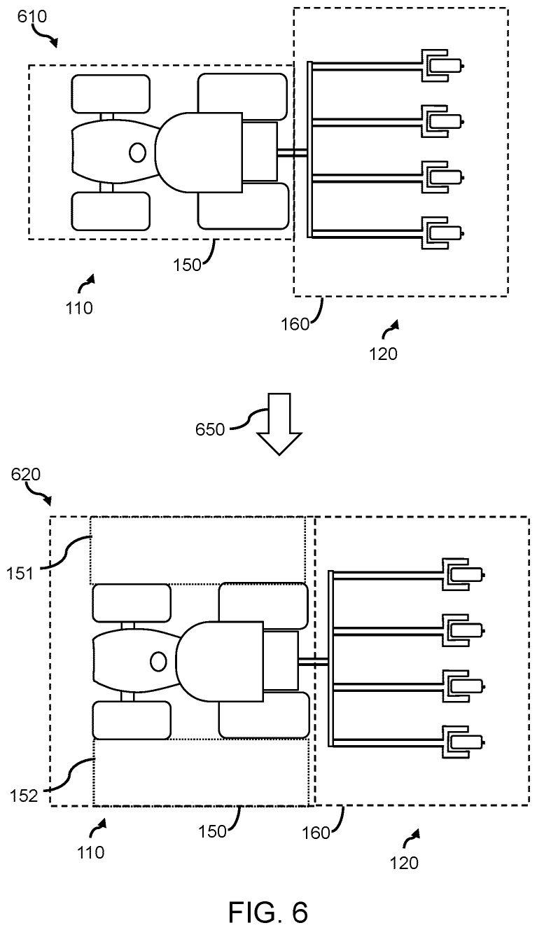

FIG. 5 illustrates a method 500 that takes account of this recognition.

Method 500 differs from previously described method 300 by further comprising a step 525 of obtaining a vehicle indicator providing information about one or more characteristics of the agricultural vehicle,

The one or more characteristics are preferably characteristics that affect a potential future location of the implement being towed by the agricultural vehicle, such as a steering angle of the agricultural vehicle or a speed of the agricultural vehicle.

Step 330 is accordingly modified to define the size and/or shape of the first side zone in dependence on the implement indicator and the vehicle indicator.

In one example, step 330 comprises a sub-step 531 of processing the implement indicator and the vehicle indicator to predict a future location of the implement. It will be appreciated that the future location of the implement can be readily predicted by processing such characteristics. For instance, the steering angle of the vehicle will affect a future location of the implement, as will the angle that the implement makes with respect to the vehicle. This information can be used to accurately predict a movement direction for the implement.

Step 330 may further comprise a sub-step 532 of defining the size and/or shape of the first and second side zones in dependence on the predicted future location of the implement. For instance, the first and/or second side zones may be configured or shaped to extend from a rear of the agricultural vehicle towards an expected movement direction or future locations of the implement. Thus, the first and/or second side zones may be shaped to include a region that is predicted to be occupied by the implement in the future.

In particular, step 531 may comprise processing the implement indicator and the vehicle indicator to predict the most likely regions to the side(s) of the agricultural vehicle that will become occupied by the implement in the future. This may, for instance, be based on the steering angle of the vehicle, the size of the implement and/or the angle between the implement and the vehicle. The determined regions may then be used to define the size and/or shape of the side zones in step 532. In particular, the side zones may be configured to correspond to the determined regions that are likely to be occupied. In one example, the side zones may directly match the determined regions. In a preferred example, the side zones match a scaled version of the determined regions (e.g., to account for errors and/or proximity effects of the implement), e.g. enlarged by 110% or 120%.

Step 531 may perform this procedure using a kinematics-based approach. This provides a technique for accurately predicting the likely future location of the implement, and therefore the likely regions that will be occupied by the implement.

Another approach to performing step 330 is to first use the implement indicator to determine a size and/or shape of the second alert zone that surrounds the implement indicator. This can be performed using existing approaches for setting or defining such a second alert zone.

The first and second side zones of the first alert zone may then be extended or enlarged in a direction perpendicular to the movement direction of the vehicle (e.g., determined from at least the vehicle indicator obtained in step 525). The size of the enlargement may be responsive to the size of the second alert zone, e.g., such that the bounds of the first/second side zones of the first alert zone align with those of the second alert zone.

FIG. 6 conceptually illustrates this approach. At a first point 610 in time, the first alert zone 150 and second alert zone 160 are generated. The size and/or shape of the first and second side zones 151, 152 are then defined (in a process 650) such that the bounds of the first alert zone 150 align with the bounds of the second alert zone. This is performed by extending the first alert zone in a direction perpendicular to a movement direction of the vehicle and/or implement. In this way, at a second point 620 in time, the first and second side zones have been modified.

In the previously described examples, the implement indicator is effectively used to control the size and/or shape of the side zones of the first alert zone to include an area that is likely to be occupied by the implement in the future.

The previously identified example characteristics of the implement that may be included in the implement indicator are not exhaustive, and other characteristics of the implement may affect the size/shape of the region that is likely to be influenced or occupied by the implement in the future.

By way of example, a mode of operation of the implement (e.g., its shape or activity) will influence a future region occupied/influenced by the implement. Thus, the size and/or shape of the first and second side zones may be modified responsive to a mode of operation of the implement.

For instance, if the implement indicator contains an indication of whether or not the implement is distributing material (e.g., seed, fertilizer, water etc.). Responsive to the implement distributing material, the size of the first and second side zones may be increased (compared to when the implement is not distributing material). Response to the implement not distributing material, then the size of the first and second side zones may be decreased (compared to when the implement is distributing material).

As another example, the implement indicator may contain an indication of whether the implement is in a first shape or a second (larger) shape. For instance, the implement may be water distributor configured to switch between a travelling mode (in which the water distribution equipment is stowed) and a distribution mode (in which the water distribution equipment is unstowed. Responsive to the implement being in the second shape, the size of the first and second side zones may be increased (compared to when the implement is in the second shape). Responsive to the implement being in the first shape, then the size of the first and second side zones may be decreased (compared to when the implement is in the second shape).

From the foregoing examples, it will be apparent that a wide variety of possible characteristics of the implement could be used in the modification of the size and/or shape of the side zones.

In some embodiments, the implement indicator is generated by an implement sensor positioned on the agricultural vehicle.

By way of example, the implement sensor may comprise a camera to capture an image data (e.g., an image or video) of the implement. The image data can then be processed using an object-identification or object recognition procedure to identify characteristics of the implement, such as its size, identity (using appropriate classification techniques) and/or type (similarly using appropriate classification techniques).

If used, the camera for capturing such image data may form part of the perception system used to monitor the alert zone.

As another example, the implement sensor may comprise a data processing system configured to receive data from the implement (e.g., control and/or sensing data received over a bus). This data can be processed to identify one or more characteristics of the implement, such as information about the identity or type of the implement, or an operational state of the implement. It is well established, in modern agricultural practices, that implements can provide data to the agricultural vehicle. This data can be unique or specific to a particular type/identity of implement.

As yet another example, the implement sensor may comprise an RFID sensor for performing identification of a RFID transmitter carried by the implement. This allows the type and/or identity of the implement to be readily determined.

In examples in which the implement indicator contains information on the angle that the implement makes with respect to the vehicle, the implement sensor may comprise an angle sensor. Example angles sensors include camera-based sensors (e.g., as disclosed by US 2014/0085472 A1) and a position sensor on a coupler for connecting the implement to the vehicle.

By way of example, a camera may be configured to capture or identify predetermined identifying markings or symbols on the implement (such as ArUco markers). The identified location of the markings within the image can be used to determine a pose (i.e., orientation and/or position) of the implement with respect to the vehicle. The determined pose defines an area or region occupied by the implement, and can therefore be used to generate the first and second side zones, e.g., to cover areas that are likely to be occupied by the implement in the future. Thus, the determined pose of the implement is an example of data for the implement indicator.

Of course, the determined pose could (also) be used to generate the second alert zone (if present/generated) that surrounds the implement.

As yet another example, the implement sensor may comprise a LiDAR system for performing a LiDAR scanning processing of the implement indicator. The output of a LiDAR scanning process, following standard procedures, may be a determined pose of the implement with respect to the vehicle. As previously explained, this facilitates identification or prediction of a future location of the implement with respect to the vehicle, which can in turn be used to set the size and/or shape of the side zone(s).

In some examples, one or more characteristics for the implement indicator is/are provided at a user input interface. For instance, an operator of the agricultural vehicle may be able to indicate a type or identity of the implement coupled to the agricultural vehicle. As another example, the operator may be able to indicate a size and/or shape of the implement. This provides an alternative mechanism to a dedicated implement sensor.

Above described approaches may be configured to further define a second alert zone that surrounds the implement towed by the agricultural vehicle in dependence on the implement indicator. For instance, the size and/or shape of the second alert zone may be defined responsive to the implement indicator. For instance, the shape of the second alert zone may be configured to match or mirror the shape of the implement (e.g., as defined by the type and/or identity of the implement). As another example, the size of the second alert zone may be defined proportional to the defined size of the implement, e.g., as defined by the type and/or identity of the implement.

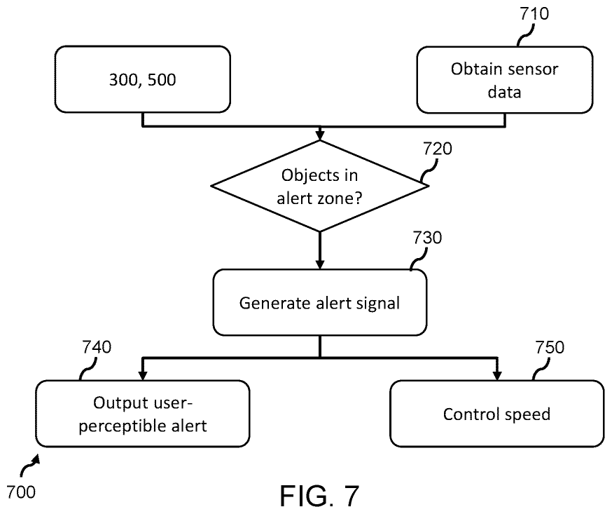

FIG. 7 is a flowchart illustrating a method 700 with further optional steps.

The method 700 comprises a process 300, 500 of defining an alert zone using any previously described approach.

The method 700 further comprises a step 710 of obtaining sensor data responsive to the presence of one or more target objects in the vicinity of the agricultural vehicle. The sensor may, for instance, generate LiDAR data, RADAR data, ultrasound data and/or image data (e.g., images and/or videos).

The method 700 further comprises a step 720 of processing the sensor data to determine whether or not the one or more target objects are within the alert zone. Approaches for performing this process are well established in the field. Examples of target objects are well known, including persons, animals, solid objects (such as walls) and/or hazardous objects (such as other vehicles).

The method 700 further comprises a step 730 of controlling an alert signal that indicates whether or not the one or more target objects are within the alert zone. Thus, the data carried by the alert signal will change responsive to the detected presence or absence of any target object(s) in the alert zone.

Of course, step 720 may comprise processing the sensor data to determine whether or not the one or more target objects are within the second alert zone (if present) that surrounds the implement. Similarly, step 730 may comprise, if the second alert zone surrounding the implement is present, further controlling the alert signal responsive to whether or not the one or more target objects are within the second alert zone.

The alert signal can be used for a variety of purposes.

In one example, the method 700 comprises a step 740 of controlling, via a user interface, a user-perceptible output responsive to the alert signal. The user interface may be carried by the agricultural device (e.g., mounted in a cabin or the like) for alerting the operator of the agricultural device to the presence of one or more target object(s) in the alert zone or (if present) the second alert zone.

In an example, the method 700 comprises a step 750 of controlling, via a drive control system, a speed of the agricultural vehicle responsive to the alert signal. For instance, step 750 may comprise slowing or stopping the agricultural vehicle response to the alert signal indicating the presence of one or more target object(s) in the alert zone or (if present) the second alert zone. This improves the safety of the agricultural vehicle towing an implement from a rear thereof.

Some embodiments of the invention make use of one or more machine-learning methods (e.g., for performing target object identification). Any suitable machine-learning model may be used in different embodiments for the present disclosure. Suitable machine-learning models include (artificial) neural networks, support vector machines (SVMs), Naïve Bayesian models and decision tree algorithms, although other appropriate examples will be apparent to the skilled person.

There are a number of well-established approaches for training a machine-learning model. Typically, such training approaches make use of a large database of known input and output data. The machine-learning model is modified until an error between predicted output data, obtained by processing the input data with the machine-learning model, and the actual (known) output data is close to zero, i.e. until the predicted output data and the known output data converge. The value of this error is often defined by a cost function. The precise mechanism for modifying the machine-learning model depends upon the type of model. Example approaches for use with a neural network include gradient descent, backpropagation algorithms and so on.

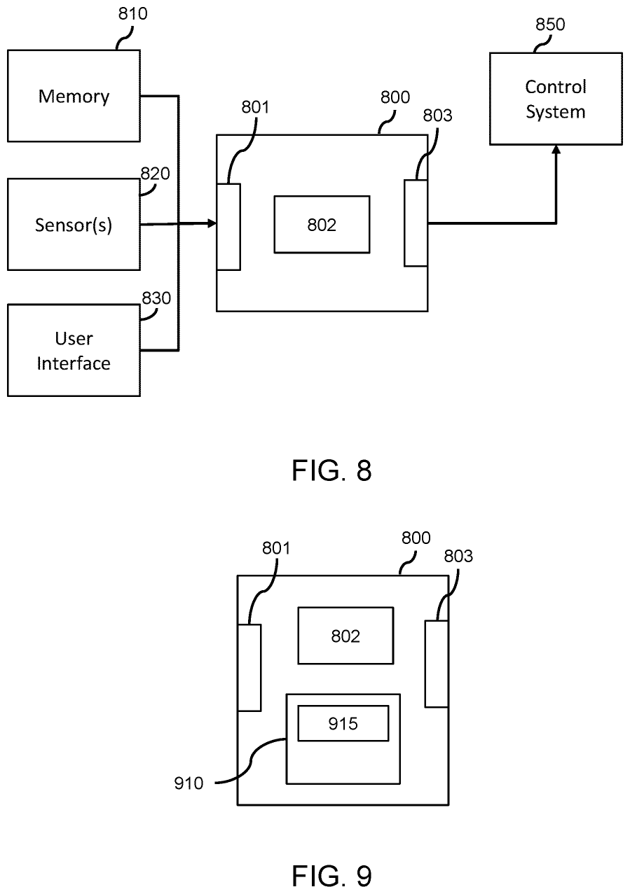

FIG. 8 illustrates a processing system 800 according to an embodiment. The processing system is configured to perform any herein described method 200. In particular, the processing system is configured for defining an alert zone that surrounds the agricultural vehicle

The processing system 800 may, for instance, be carried by an agricultural vehicle configured to tow an implement from a rear thereof. The agricultural vehicle is an embodiment of the invention.

The processing system 800 may form an integral part of the processing circuitry of the agricultural vehicle, e.g., be integrated into the on-board processing system of the agricultural vehicle. However, this is not essential. In some approaches, the processing system may be a separate, add-on system for the agricultural vehicle that is able to operate independently of the processing performed by the vehicle.

The processing system 800 is configured to define, in the alert zone, a first side zone and a second size zone positioned on either side of the agricultural vehicle and spanning from a front of the agricultural vehicle to the rear of the agricultural vehicle. Information on the alert zone may be defined in a memory or storage unit 810.

The processing system is also configured to obtain an implement indicator that provides information on one or more characteristics of the implement. The implement indicator may be obtained from a memory or storage unit 810 and/or from one or more sensors 820 and/or from a user interface 830.

The processing system 800 may comprise an input interface 801 configured to receive the above-identified data.

The processing system 800 is configured to define a size and/or shape of the first side zone and the second side zone in dependence on the implement indicator. This process may be carried out by a processing unit 802 of the processing system 800.

The processing system 800 may be configured to provide the defined size and/or shape of the first side zone and the second side zone to an external component, such as the memory or storage unit 810 or a further processor 850. The further processor 850 may, for instance, use the defined size and/or shape of the first and second side zones in performing object detection within the alert zone, e.g., for generating or controlling an alert signal

In some examples, the further processor 850 itself forms part of the processing system 800.

Any output of the processing system may be controlled via an output interface 803. In particular, the output of the processing system may be defined by the processing unit 802 of the processing system via the processing unit.

FIG. 9 illustrates an embodiment of the processing system 800 described with reference to FIG. 8. The processing system is able to carry out or perform one or more embodiments of an invention, e.g. for defining an alert zone that surrounds an agricultural vehicle.

The processing system 800 comprises an input interface 801 that receives communications from one or more inputting devices. Examples of suitable inputting devices include external memories, user interfaces (such as mice, keyboards, microphones, sensors and so on).

The processing system 800 also comprises a processing unit 802.

In one example, the processing unit 802 may comprise an appropriately programmed or configured single-purpose processing device. Examples may include appropriately programmed field-programmable gate arrays or complex programmable logic devices.

As another example, the processing unit may comprise a general purpose processing system (e.g. a general purpose processor or microprocessor) that executes a computer program 915 comprising code (e.g. instructions and/or software) carried by a memory 910 of the processing system 800.

The memory 910 may be formed from any suitable volatile or non-volatile computer storage element, e.g. FLASH memory, RAM, DRAM, SRAM, EPROM, PROM, CD-ROM and so on. Suitable memory architectures and types are well known to the person skilled in the art.

The computer program 915, e.g. the software, carried by the memory 910 may include comprise a sequence of instructions that are executable by the processing unit for implementing logical functions to carry out the desired method or procedure. Each instruction may represent a different logical function, step or sub-step used in performing a method or process according to an embodiment. The computer-program may be formed from a set of sub-programs, as would be known to the skilled person. The computer program 915 may be written in any suitable programming language that can be interpreted by the processing unit 802 for executing the instructions. Suitable programming languages are well known to the skilled person.

The processing system 800 also comprises an output interface 803. The processing system may be configured to provide information via the output interface.

Different components of the processing system 800 may interact or communicate with one another via one or more intra-system communication systems (not shown), which may include communication buses, wired interconnects, analogue electronics, wireless communication channels (e.g. the internet) and so on. Such intra-system communication systems would be well known to the skilled person.

It is not essential for the processing system 800 to be formed on a single device, e.g. a single computer. Rather, any of the system blocks (or parts of system blocks) of the illustrated processing system may be distributed across one or more computers.

The skilled person would be readily capable of developing a processing system for carrying out any herein described method. Thus, each step of the flow chart may represent a different action performed by a processing system, and may be performed by a respective module of the processing system.

It will be understood that disclosed methods are preferably computer-implemented methods. As such, there is also proposed the concept of a computer program comprising code means for implementing any described method when said program is run on a processing system, such as a computer. Thus, different portions, lines or blocks of code of a computer program according to an embodiment may be executed by a processing system or computer to perform any herein described method.

A computer program may be stored on a computer-readable medium, itself an embodiment of the invention. A “computer-readable medium” is any suitable mechanism or format that can store a program for later processing by a processing unit. The computer readable medium can be, for example but not limited to, an electronic, magnetic, optical, electromagnetic, infrared, or semiconductor system, apparatus or device. The computer-readable medium is preferably non-transitory.

In some alternative implementations, the functions noted in the block diagram(s) or flow chart(s) may occur out of the order noted in the figures. For example, two blocks shown in succession may, in fact, be executed substantially concurrently, or the blocks may sometimes be executed in the reverse order, depending upon the functionality involved.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. If a computer program is discussed above, it may be stored/distributed on a suitable medium, such as an optical storage medium or a solid-state medium supplied together with or as part of other hardware, but may also be distributed in other forms, such as via the Internet or other wired or wireless telecommunication systems. If the term “adapted to” is used in the claims or description, it is noted the term “adapted to” is intended to be equivalent to the term “configured to”. If the term “arrangement” is used in the claims or description, it is noted the term “arrangement” is intended to be equivalent to the term “system”, and vice versa. Any reference signs in the claims should not be construed as limiting the scope.

All references cited herein are incorporated herein in their entireties. If there is a conflict between definitions herein and in an incorporated reference, the definition herein shall control.

1. A computer-implemented method for defining an alert zone that surrounds an agricultural vehicle towing an implement from a rear of the agricultural vehicle, the computer-implemented method comprising:
defining, in the alert zone, a first side zone and a second side zone positioned on either side of the agricultural vehicle and spanning from a front of the agricultural vehicle to the rear of the agricultural vehicle;
obtaining an implement indicator providing information on one or more characteristics of the implement; and
defining a size and/or shape of at least the first side zone and the second side zone in dependence on the implement indicator.

2. The computer-implemented method of claim 1, wherein the implement indicator is generated by an implement sensor positioned on the agricultural vehicle.

3. The computer-implemented method of claim 1, wherein the implement indicator provides information on a type or identity of the implement towed by the agricultural vehicle.

4. The computer-implemented method of claim 1, wherein the implement indicator provides information on an angle, in a horizontal plane, between the vehicle and the implement.

5. The computer implemented method of claim 1, wherein the implement indicator provides information on an operational state of the implement.

6. The computer implemented method of claim 5, wherein the implement comprises an active implement; and wherein the size and/or shape of the first and/or second side zones is/are defined and/or varied in dependence on a varying operational state of the implement.

7. The computer-implemented method of claim 1, further comprising obtaining a vehicle indicator providing information on one or more characteristics of the agricultural vehicle,
wherein defining the size and/or shape of the first side zone and the second side zone is further in dependence on the vehicle indicator.

8. The computer-implemented method of claim 7, wherein the vehicle indicator provides information on a speed of the agricultural vehicle.

9. The computer-implemented method of claim 7, wherein the vehicle indicator provides information on a steering angle of the agricultural vehicle.

10. The computer-implemented method of claim 7, wherein defining a size and/or shape of the first side zone and the second side zone comprises:
processing the implement indicator and the vehicle indicator to predict a future location of the implement; and
defining the size and/or shape of the first side zone and second side zone in dependence on the predicted future location of the implement.

11. The computer-implemented method of claim 1, wherein neither the first side zone nor the second side zone cover an area occupied by the implement.

12. The computer-implemented method of claim 1, wherein:
the step of defining a size and/or shape of the first side zone and the second side zone comprises, for each of the first and second side zones, defining a size and/or shape of at least a portion of said side zone that spans from the front of the agricultural vehicle to a center-line of the agricultural vehicle, being a line equidistant from the front and rear of the agricultural vehicle, in dependence on the implement indicator.

13. The computer-implemented method of claim 1, further comprising defining a second alert zone that surrounds the implement towed by the agricultural vehicle in dependence on the implement indicator.

14. The computer-implemented method of claim 1, further comprising:
obtaining sensor data responsive to the presence of one or more target objects in the vicinity of the agricultural vehicle;
processing the sensor data to determine whether or not the one or more target objects are within the alert zone; and
controlling an alert signal that indicates whether or not the one or more target objects are within the alert zone.

15. The computer-implemented method of claim 14, further comprising:
controlling, via a user interface, a user-perceptible output responsive to the alert signal; and/or
controlling, via a drive control system, a speed of the agricultural vehicle responsive to the alert signal.

16. A computer program product comprising computer program code means which, when executed on a computing device having a processing system, cause the processing system to perform all of the steps of the method according to claim 1.

17. A processing system for defining an alert zone that surrounds agricultural vehicle configured to tow an implement from a rear thereof, the processing system being configured to:
define, in the alert zone, a first side zone and a second size zone positioned on either side of the agricultural vehicle and spanning from a front of the agricultural vehicle to the rear of the agricultural vehicle;
obtain an implement indicator providing information on one or more characteristics of the implement; and
define a size and/or shape of the first side zone and the second side zone in dependence on the implement indicator.
